(19) United States
(12) Patent Application Publication
(10) Pub. No.: US 2005/0166971 A1
(43) Pub. Date: Aug. 4, 2005

(54) Y-pattern piston check valve, piston valve assembly for a Y-pattern piston check valve, and method

(76) Inventors: Gennady Arov, Bayside, WI (US); David Stein, West Allis, WI (US)

Correspondence Address: David D. Stein, 900 South 91st Street, West Allis, WI, 53214, US

(21) Appl. No.: 11/048,302

(22) Filed: Jan. 31, 2005

Related U.S. Application Data
(60) Provisional application No. 60/541,139, filed on Jan. 31, 2004.

(51) Int. Cl. F16K 15/06

(52) U.S. Cl. 137/543.13

(57) ABSTRACT

A valve that includes a valve body in which a valve piston is disposed. The valve piston has a disc and an elongate stem that is reciprocably carried by a valve guide. The valve guide is part of an assembly that includes an cap that is attached to a Y-pattern valve body. The valve body has a valve seat that preferably is an integral hard seat and the disc has a sealing surface that preferably is a hard surface. Where operation independent of the effects of gravity is desired, a biasing element, preferably a coil spring captured in compression, is disposed in communication with the valve guide and the stem of the piston. A tolerance is provided between the stem and guide that permits angular and lateral adjustment of the disc during closing that compensates for mislocation and/or misalignment between the cap and valve body.

### CROSS REFERENCE TO RELATED APPLICATION

This application claims priority under 35 U.S.C. §119(e) in U.S. Provisional Patent Application No. 60/541,139, filed Jan. 31, 2004, the entirety of which is expressly incorporated herein by reference.

### FIELD OF THE INVENTION

The present invention is directed to a Y-pattern piston check valve and more particularly to a Y-pattern piston check valve capable of using a horizontal swing check Y-pattern valve body, a piston valve assembly that includes a cap construction therefor, as well as a method of fabrication and assembly.

### BACKGROUND OF THE INVENTION

There are countless types and configurations of valves used in controlling and regulating fluid flow. One particular type of valve is a check valve used to permit fluid flow in one direction and prevent fluid flow in the opposite direction. While there are many types of check valves, only a few types are used in the vast majority of commercial and industrial applications having a valve size of between ¼ inch and 4 inches.

Commercial and industrial check valves typically have a metallic body that is usually made of brass, bronze or steel, and have a movable disc or plug that is received in a valve seat when the valve is preventing fluid flow and that is displaced from the valve seat when the valve is allowing fluid flow. The valve body is cast or forged and the disc is usually machined or forged. Additional components are usually required to assemble the disc to the valve body.

One type of check valve is a lift check valve, which has a plug, piston, disc or ball received inside the valve body that moves up to allow fluid flow and moves down onto a valve seat to block fluid flow. A lift check valve typically is oriented such that gravity assists to help pull the plug, piston, disc or ball down onto the valve seat when the valve is obstructing fluid flow.

One example of a lift check valves is shown on page 37 of Valve Functions and Basic Parts, DOE-HDBK-1018/2-93. This lift check valve is horizontally oriented and has a plug or disk that lifts to permit fluid flow and that lowers onto a valve seat when obstructing fluid flow. The valve bonnet has a guide extending from it that appears to be a component separate from the bonnet, which increases cost and the number of manufacturing steps required. In addition, the bonnet requires at least two bolts to attach it to the valve body, which means more components and additional assembly steps. Furthermore, this valve also has valve seat separate from the valve body, which is an additional component that adds to the cost of the valve and increases the number of assembly steps required.

Another lift check valve is made by King Gate Metal Corporation of No. 57, Hou Sheng Road, Sheng Kang Hsiang, Taichung Hsien, Taiwan, and marketed as its FIG. 6300, Class 125 horizontal bronze lift check valve. The valve has a valve cap with a bore in that receives a stem of a valve disc that is received on a valve seat when obstructing fluid flow and that is displaced from the valve seat when permitting fluid flow. The valve disc or seat has downwardly extending flutes that extend downwardly below the valve seat when the disc is seated on the valve seat. These flutes add to the cost to make the valve and increase the complexity of the valve, all of which increases costs and requires additional manufacturing steps.

Another horizontal lift check valve is the Model 50LS lift check valve made by United Brass Works of 714 South Main Street of Randleman, N.C., which has a valve disc with a stem that is reciprocably received in a guide that is releasably secured to the valve body by a bonnet nut. There is a separate Buna-N soft disc washer that is attached to the valve disc by a nut that threads to a bolt extending out the bottom of the disc. All of these additional components cost money and require additional assembly steps, all of which increase valve cost.

Another valve made by United Brass Works is an air control valve publicly sold as the Model 55 spring check valve. This valve is a horizontal spring biased lift check or piston valve that has a brass cap attached to a bronze valve body with the cap reciprocably receiving a brass disc holder assembly that is biased by a spring between it and the cap. The disc holder assembly includes a soft replaceable valve disc held in place by nut received on a threaded outwardly extending stud at the free end of the disc holder assembly. Unfortunately, the valve body is of non-standard design and is limited to air flow control applications. In addition, because the surface area of the rear face of the disc holder assembly is small relative to the front face of the valve disc and nut, response time is undesirably slow, also making it unacceptable for liquid flow control applications.

Trustkeen Company of 30 Shing Yip Street, Kwun Tong, Kowloon, Hong Kong China commercially markets and sells a stainless steel horizontal piston check valve and a stainless steel Y-pattern piston check valve under its part numbers PN 10-40 and PN 25-40. These check valves use a cover that is attached to the valve body by bolts and nuts. They also have a graphite gasket located between the cover and the valve body. The bolts, nuts and gasket are additional components that add cost as well as additional costly assembly steps. In addition, the valve body of the Y-pattern valve is of non-standard construction, which limits its use and makes replacement costly.

Tyco International of 9 Roszel Road of Princeton, N.J., has a division called Tyco Flow Control, which markets a line of valves under the Hancock trade name, including the Series 4000, which is a Y-pattern lift check valve made in sizes that range between ½ inch and 4 inches. The valve has a forged steel valve body with a renewable hard faced seat that requires an additional expensive manufacturing step. The valve cap is threaded into the valve body and has a precision machined valve disc and valve stem guide bore in which a one-piece valve stem and disc is reciprocably received. The valve stem is precision machined, heat treated and precision guided to eliminate disc vibration, misalignment of seating surfaces, cocking, and side loading of the disc. In addition to being accurately machined, the valve disc and valve stem guide bores precision machined in the valve cap are fully hard faced to reduce wear and increase valve life. 1.he precise construction, hard facing and heat treating required for this valve greatly increases manufacturing expense making this valve time consuming and relatively costly to make.

There is a class of commercial and industrial valves that require a pressure rating of at least 150 pounds per square inch (psi) water supply point (WSP) and/or at least 200 psi water-oil-gas (WOG). Such commercial and industrial check valves also must conform to specification MSS SP-80 or more stringent. Such check valves usually must also be certified for high temperature applications with a rating of at least 400° Fahrenheit (F) WSP and at least 100° F. WOG.

One popular type of check valve made to conform to such specifications is a swing check valve that has a circular valve disc attached to a hinge that is pivotally mounted by a hinge pin to the valve body. Examples of such swing check valves of Y-pattern configuration include Class 125, Class 200 and Class 200 Y-pattern, threaded cap bronze swing check valves commercially made and sold under the STOCKHAM trade name of Crane Co. of 2129 3rd Avenue SE, Cullman, Ala. These valves include valves marketed under the designation of Fig. B-320TY, Fig. B-309Y, Fig. B-319Y, Fig. B-345, and Fig. B-375. Unfortunately, swing check valves, including the aforementioned STOCKHAM Y-pattern swing check valves, require additional components and assembly steps to attach the disc to the hinge and the hinge to the valve body, all of which undesirably increase cost and reduce reliability. In addition, swing check valves cannot be used in any orientation as they must always be properly oriented relative to gravity or they will not work.

What is needed is a simple and economical valve construction of Y-pattern configuration that is capable of being implemented in standard, low cost Y-pattern valve bodies used in Y-pattern swing check valves and Y-pattern valve bodies based on valve bodies used in Y-pattern swing check valves.

### SUMMARY OF THE INVENTION

The present invention is directed to a valve and an assembly therefor, a method of making, a method of assembling, and a method of operation. The valve includes a valve body that has an inlet, outlet, an interiorly located valve seat that has an orifice through it, and a valve assembly port. The valve further includes a valve guide assembly that is received in the valve assembly port with the assembly including a valve guide. The valve further includes a valve sealing element that is slidably reciprocably carried by the valve guide which bears against the valve seat when in a closed position and which is spaced from the valve seat when in an open position.

In one preferred embodiment, the valve also includes a biasing element that is in communication with the valve guide and the valve sealing element which urges the valve sealing element toward the closed position. Where equipped with such a biasing element, the biasing element preferably comprises a coil spring that is captured in compression.

In a currently preferred embodiment, the valve body, end cap, and valve sealing element are all made of metal. Preferred metals include brass or bronze.

In one preferred embodiment, the valve seat comprises an annular ring that encircles the valve orifice. The valve seat is integrally formed in a sidewall inside the valve body that is preferably disposed at an acute angle relative to a bottom wall of the valve body. The valve seat preferably is a hard seat of metallic construction. In a preferred embodiment, the valve seat has a curvilinear cross section that can be semicircularly shaped.

In a preferred embodiment, the valve body, including the valve seat, inlet, outlet, and valve assembly port are of one-piece unitary construction such that they are formed from one piece of material. In one preferred implementation, the valve body is cast and, to the extent needed, machined to tolerance. In one preferred implementation, surfaces of the inlet, outlet, valve assembly port, and valve seat are machined.

The valve sealing element has a valve seat sealing surface that is disposed along an exterior face of the head. In a preferred embodiment, the valve seat sealing surface is a hard valve seat sealing surface that comes into direct contact with the valve seat of the valve body when the valve sealing element is disposed in a fully closed position. In a preferred embodiment, the valve sealing element, including its head and stem, is of one-piece and unitary construction such that it is formed from one piece of material.

The valve guide assembly preferably comprises an end cap that carries a valve guide that can be of ported construction. In one preferred embodiment, the valve guide is of tubular construction and can accommodate a biasing element therein. In one preferred embodiment, the end cap and the valve guide are of one-piece unitary construction such that they are formed from one piece of material.

In one preferred embodiment, the valve guide assembly and valve sealing element form an assembly that can be used for retrofit applications. In putting together this particular assembly, the stem of the valve sealing element is telescopically slidably received by the valve guide of the valve guide assembly. In a preferred embodiment, the stem of the valve sealing element is telescopically slidably received in the valve guide of the valve guide assembly.

Where used in retrofit applications, the retrofit assembly is put together before being assembled to a valve body; such as a swing check valve body that is of Y-construction. Of course, before assembly, the innards of the valve are removed to permit the retrofit assembly to be assembled thereto.

8. One preferred valve assembly has a valve stem of a first diameter, a valve guide of a second diameter, and a valve head or disc of a third diameter, and is configured such that the valve disc diameter is greater than the valve stem diameter and the valve guide diameter providing an overhang of at least about one-eighth of an inch. In another preferred embodiment, the valve stem has a first diameter, the valve guide has a second diameter, the valve head has a third diameter, and the valve guide diameter is no greater than one-third the valve head diameter. In still another preferred embodiment, the valve guide diameter is about one-fourth the valve head diameter. In a further preferred embodiment, the valve guide has a diameter and the valve head has a thickness that is about one-half the diameter of the valve guide.

In one preferred embodiment, there is an angular tolerance between the valve stem and the valve guide between one degree and three and one-half degrees when disposed in a closed position. In another preferred embodiment, there is an angular tolerance between the valve stem and the valve guide of about two degrees.

In one preferred embodiment, the valve is a three-quarter inch NPT valve having a tolerance of eight thousandths of an inch that provides a one degree angular adjustment tolerance. In another preferred embodiment, the same size valve has a fifteen thousandths tolerance that permits the valve sealing element to angularly adjust as much as about two degrees.

A piston-type valve constructed in accordance with the invention has a valve stem of a piston-type valve sealing element reciprocably received in the valve stem guide of the valve body such that there is a loose sliding fit therebetween. The gap or tolerance between the valve stem and the valve stem guide is chosen to provide the desired loose sliding fit that enables the disc to pivot about its initial point of contact with the valve seat. Choosing a gap or tolerance between the valve stem and the valve stem guide that produces the desired loose sliding fit therebetween in accordance with a piston-type valve of the invention also advantageously enables the valve disc to laterally displace relative to the valve seat as needed so as to more fluid tightly seal against the seat.

It is an object of the present invention to provide a valve guide assembly and valve sealing element that is capable of retrofit use.

It is another object of the present invention to provide a valve guide assembly and valve sealing element that uses a minimum of components.

It is a further object of the present invention to provide a valve guide assembly and valve sealing element that is of simple construction, easy and inexpensive to make, easy and inexpensive to assemble, and easy and inexpensive to ship, install, and use.

It is still another object of the present invention to provide a valve that is capable of use in high flow and high pressure applications.

It is still a further object of the present invention to provide a valve that is of simple construction and which uses a minimum of components to provide one-way valve flow regulation.

It is an advantage of the present invention in that a valve is provided that can be quickly, easily, economically, and durably fabricated.

It is another advantage of the present invention in the valve is provided that is durable, long-lasting, reliable, and repeatable.

Other objects, features, and advantages of the present invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout and in which:

FIG. 1 is an exploded perspective view of a first preferred embodiment of a Y-pattern piston check valve constructed in accordance with the invention;

FIG. 2 is a cross sectional side view of a Y-pattern horizontal swing check valve body;

FIG. 3 is a perspective view of a piston valve assembly constructed in accordance with the invention;

FIG. 4 is a side elevation view of a valve cap that has an integral piston valve stem guide;

FIG. 5 is a front plan view of the cap shown in FIG. 4;

FIG. 6 is a perspective view of a second preferred embodiment of a valve cap that equipped with a piston valve stem guide;

FIG. 7 is a front perspective view of a preferred embodiment of a valve piston;

FIG. 8 is a bottom perspective view of the valve piston shown in FIG. 7;

FIG. 9 is a cross sectional view of a second preferred embodiment of a Y-pattern piston check valve constructed in accordance with the invention with the piston valve in an open position;

FIG. 10 is a cross sectional view of the Y-pattern piston check valve shown in FIG. 9 with the piston valve in a closed position;

FIG. 11 is an enlarged fragmentary cross sectional view of a portion of the valve shown in FIGS. 9 and 10 depicting a tolerance or gap between the stem of the valve piston and the valve stem guide that permits lateral and angular adjustment of the valve piston relative to the valve seat when the valve piston is closing;

FIG. 12 is an enlarged fragmentary cross sectional view of a portion of the valve shown in FIGS. 9 and 10 depicting angular adjustment of the valve piston during closing to compensate for mislocation and/or misalignment between the cap and the valve body;

FIG. 13 is a cross sectional view of a third preferred embodiment of a Y-pattern piston check valve constructed in accordance with the invention with the piston valve in an open position but biased by a biasing element toward its closed postion;

FIG. 14 is a cross sectional view of the Y-pattern piston check valve shown in FIG. 13 with the piston valve biased by the biasing element in a closed position; and

FIG. 15 is a cross sectional view of a preferred embodiment of a lapping fixture used to lap the valve piston against the valve seat.

### DETAILED DESCRIPTION OF AT LEAST ONE PREFERRED EMBODIMENT

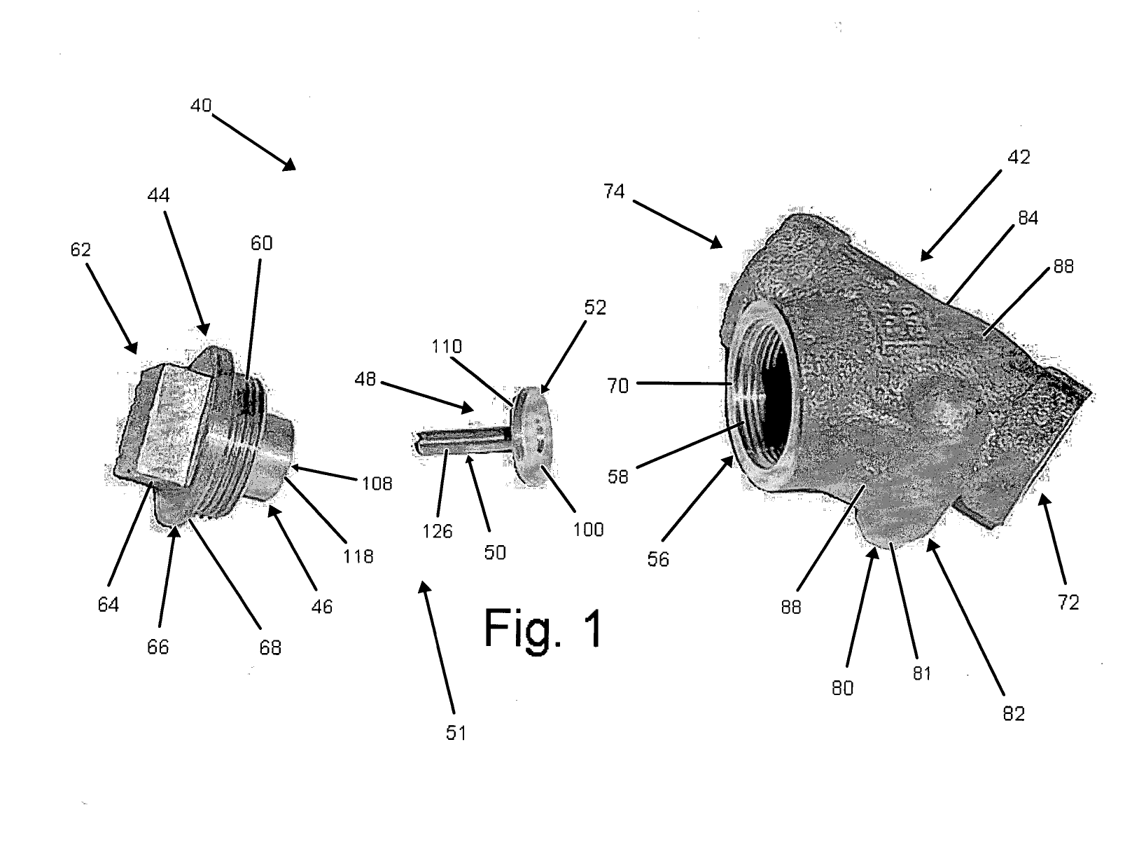

FIG. 1 illustrates a preferred embodiment of a Y-pattern piston check valve 40 constructed in accordance with the invention that includes a Y-pattern valve body 42, a bonnet or cap 44 that threadably attaches to the valve body 42 and that has an outwardly extending valve stem guide 46, and a valve piston 48 that includes an outwardly extending elongate valve stem 50 reciprocably received in the guide 46. During operation, fluid flow is permitted through the valve 40 when the piston 48 is located in an open position and fluid flow is opposed when the piston 48 is located in a closed position.

The valve 40 is constructed such that some space is intentionally provided between the valve stem 50 and the valve stem guide 46 to permit the piston 48 to adjust and fluidtightly seal when closing despite some mislocation and/or misalignment between the cap 44 and valve body 42. This space is provided by making the outer diameter of the valve stem 50 smaller than the inner diameter of the guide 46 providing some play therebetween. The amount of space is selected to enable the piston 48 to laterally and angularly adjust relative to the valve stem guide 46 as it closes to compensate for such mislocation and/or misalignment while still providing a fluidtight seal when closed. This permits a valve 40 constructed in accordance with the invention to advantageously use a Y-pattern valve body 42 having a less precise conventionally threaded assembly port 56. For example, standard, less expensive to machine, NPT threads preferably are used.

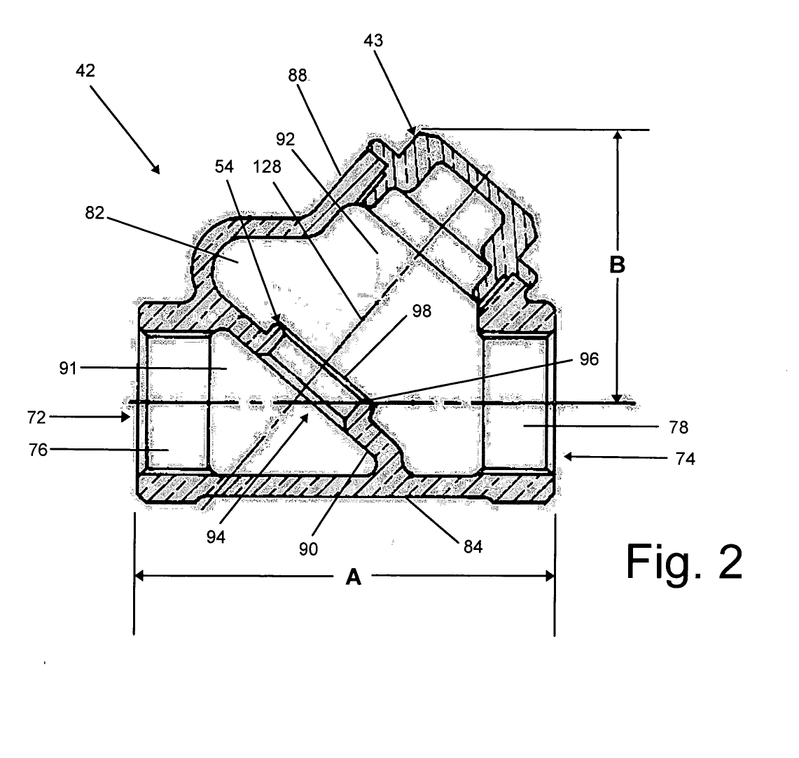

As a result, a Y-pattern valve body 42 normally used in a conventional Y-pattern horizontal swing check valve, such as also depicted in FIG. 2, can also be used as a valve body for a Y-pattern piston check valve 40 constructed in accordance with the invention. Where a Y-pattern horizontal swing check valve body 42 of the configuration depicted in FIGS. 1 and 2, the horizontal swing check valve swing arm (not shown) is not used nor is the valve disc (not shown) that is attached to the swing arm. In addition, the hinge pin is not needed nor preferably used. The only thing needed to adapt a Y-pattern horizontal swing check valve body 42 for use in a Y-pattern piston check valve 40 of the invention is a seal plug 80 in the hinge pin bore (not shown) in the valve body 42 that fluid-tightly seals its hinge pin bore (not shown).

A Y-pattern horizontal swing check valve body 42 used to make a Y-pattern piston check valve 40 in accordance with the invention is constructed so it conforms to MSS Specification SP-80, preferably Type 3, and has dimensions that are the same or substantially the same as corresponding dimensions for a Y-pattern horizontal swing check valve body for a class 125, class 150, class 200 or class 300 Y-pattern bronze swing check valve of conventional construction. Preferably, a valve 40 constructed in accordance with the present invention that utilizes a bronze Y-pattern horizontal swing check valve body 42 that has a lengthwise dimension, A, and a transverse dimension, B, measured perpendicularly from a lengthwise center lengthwise axis of the body 42 to a top or top outer edge of the cap falling within one of the corresponding dimensional ranges of one of the valve classes listed below in Table 1:

TABLE 1

| Size | ¼ inch | ⅜ inch | ½ inch | ¾ inch | 1 inch | 1¼ inch | 1½ inch | 2 inch | 2½ inch | 3 inch |
|---|---|---|---|---|---|---|---|---|---|---|
| (inch) | | | | | | | | | | |
| Size | (6 mm) | (10 mm) | (15 mm) | (20 mm) | (25.40) | (31.75) | (38.10) | (50.80) | (63.50) | (76.20) |
| (mm) | (6.35) | (9.53) | (12.70) | (19.05) | (25 mm) | (32 mm) | (40 mm) | (50 mm) | (65 mm) | (80 mm) |
| Class | 125 steam | 125 steam | 125 steam | 125 steam | 125 steam | 125 steam | 125 steam | 125 steam | 125 steam | 125 steam |
| 125 | 200 cold | 200 cold | 200 cold | 200 cold | 200 cold | 200 cold | 200 cold | 200 cold | 200 cold | 200 cold |
| | (psi) | (psi) | (psi) | (psi) | (psi) | (psi) | (psi) | (psi) | (psi) | (psi) |
| A | 2.18-.25 | 2.18-.25 | 2.19-.63 | 2.75-3.00 | 3.24-3.69 | 3.84-4.38 | 4.40-4.63 | 5.18-5.88 | 6.13-7.00 | 7.40-7.89 |
| | (55-58) | (55-58) | (55-67) | (69-77) | (82-94) | (97-112) | (111-118) | (131-150) | (155-178) | (187-201) |
| B | 1.5-1.63 | 1.5-1.63 | 1.63-1.75 | 1.91-1.94 | 2.45-2.65 | 2.90-3.00 | 3.31-3.50 | 4.00-4.25 | 4.10-4.75 | 5.00-6.00 |
| | (38-42) | (38-42) | (41-45) | (48-50) | (62-68) | (73-77) | (84-89) | (101-108) | (104-121) | (127-153) |
| Class | 150 steam | 150 steam | 150 steam | 150 steam | 150 steam | 150 steam | 150 steam | 150 steam | 150 steam | 150 steam |
| 150 | 300 cold | 300 cold | 300 cold | 300 cold | 300 cold | 300 cold | 300 cold | 300 cold | 300 cold | 300 cold |
| | (psi) | (psi) | (psi) | (psi) | (psi) | (psi) | (psi) | (psi) | (psi) | (psi) |
| A | 2.18-.25 | 2.18-.25 | 2.19-.63 | 2.75-3.00 | 3.24-3.69 | 3.84-4.38 | 4.40-4.63 | 5.18-5.88 | 6.13-7.00 | 7.40-7.89 |
| | (55-58) | (55-58) | (55-67) | (69-77) | (82-94) | (97-112) | (111-118) | (131-150) | (155-178) | (187-201) |
| B | 1.5-1.63 | 1.5-1.63 | 1.63-1.75 | 1.91-1.94 | 2.45-2.65 | 2.90-3.00 | 3.31-3.50 | 4.00-4.25 | 4.10-4.75 | 5.00-6.00 |
| | (38-42) | (38-42) | (41-45) | (48-50) | (62-68) | (73-77) | (84-89) | (101-108) | (104-121) | (127-153) |
| Class | 200 steam | 200 steam | 200 steam | 200 steam | 200 steam | 200 steam | 200 steam | 200 steam | 200 steam | 200 steam |
| 200 | 400 cold | 400 cold | 400 cold | 400 cold | 400 cold | 400 cold | 400 cold | 400 cold | 400 cold | 400 cold |
| | (psi) | (psi) | (psi) | (psi) | (psi) | (psi) | (psi) | (psi) | (psi) | (psi) |
| A | 2.18-.25 | 2.18-.25 | 2.19-.63 | 2.70-3.00 | 3.21-3.69 | 3.80-4.38 | 4.35-4.63 | 5.15-5.88 | 6.90-7.10 | 8.15-8.35 |
| | (55-58) | (55-58) | (55-67) | (67-77) | (81-94) | (96-112) | (110-118) | (130-150) | (175-180) | (207-213) |
| B | 1.52-1.63 | 1.5-1.63 | 1.67-1.75 | 1.93-1.98 | 2.50-2.70 | 3.00-3.10 | 3.35-3.55 | 4.25-4.40 | 4.60-4.75 | 5.85-6.20 |
| | (38-42) | (38-42) | (42-45) | (49-51) | (63-69) | (76-79) | (85-91) | (107-112) | (116-121) | (148-158) |
| Class | 300 steam | 300 steam | 300 steam | 300 steam | 300 steam | 300 steam | 300 steam | 300 steam | 300 steam | 300 steam |
| 300 | 600 cold | 600 cold | 600 cold | 600 cold | 600 cold | 600 cold | 600 cold | 600 cold | 1000 cold | 1000 cold |
| | (psi) | (psi) | (psi) | (psi) | (psi) | (psi) | (psi) | (psi) | (psi) | (psi) |
| A | 2.18-.25 | 2.18-.25 | 2.19-.63 | 2.75-3.00 | 3.21-3.69 | 3.80-4.38 | 4.35-4.63 | 5.15-5.88 | 6.90-7.10 | 8.15-8.35 |
| | (55-58) | (55-58) | (55-67) | (69-77) | (81-94) | (96-112) | (110-118) | (130-150) | (175-180) | (207-213) |
| B | 1.52-1.63 | 1.52-1.63 | 1.67-1.75 | 1.93-1.98 | 2.50-2.70 | 3.00-3.10 | 3.35-3.55 | 4.25-4.40 | 4.60-4.75 | 5.85-6.20 |
| | (38-42) | (38-42) | (42-45) | (49-51) | (62-68) | (76-79) | (85-91) | (107-112) | (116-121) | (148-158) |

The dimensions, A and B, are shown on the valve body 42 illustrated in FIG. 2. The valve body 42 has an inlet 72 and an outlet 74 each constructed and arranged to couple with a fluid-conveying pipe or conduit (not shown). For example, the inlet 72 of the valve body 42 shown in FIG. 2 has internal threads 76, typically NPT threads, for threadably coupling with an externally threaded end of a pipe or conduit (not shown) and the outlet 74 has internal threads 78, typically NPT threads, also for threadably coupling with an externally threaded end of a different pipe or conduit (not shown).

The valve body 42 has a bottom 84 that extends in a direction generally parallel to the direction of fluid flow through the valve, a pair of sides 86 (FIG. 1) that also extend generally parallel to the direction of fluid flow, an assembly port sidewall 88 oriented at an acute angle relative to the bottom 84, and an internal valve seat partition 90 inside the valve body in which an annular valve seat 54 is disposed. The valve seat 54 encircles a valve orifice 94 that extends completely through the partition 90. The sidewall 88 and partition 90 help define a valve chamber 92 downstream of the valve seat 54 and upstream of the outlet 74. The assembly port sidewall 88 preferably is generally perpendicularly angled relative to the valve seat 54 and the valve seat 54 preferably is acutely angled relative to the valve body bottom 84.

Preferably, the valve seat 54 is oriented at an angle of between about 30° and about 60° relative to the valve body bottom 84 and the sidewall 88 preferably is also oriented at an angle of between about 30° and about 60° relative to the bottom 84. In one preferred embodiment, the valve seat 54 is oriented at an angle of about 45° relative to the valve body bottom 84 and the sidewall 88 is also oriented at an angle of about 45° relative to the bottom 84. The valve seat partition 90, valve body bottom wall 84, and the interiorly disposed end of the threaded region 76 of the inlet 72 define a triangular inlet chamber 91, shown in FIG. 2 as having a triangular cross section, which corresponds to between about a 45°-45°-90° triangle and about a 30°-60°-90° triangle. As a result of configuration, fluid pressure drop during valve operation is advantageously low.

The valve seat 54 preferably is an annular upraised lip 96 that extends about the outer periphery of the circular valve orifice 94. The valve seat 54 has an outer sealing surface 98 against which a valve disc 52 of the piston 48 seats when it closes. The outer sealing surface 98 preferably has a curvilinear cross section outer peripheral contour such that it has a rounded shape. This produces line contact between it and the valve disc 52 when the valve piston 48 is closed.

The valve body 42, including the internal valve seat partition 90 and integral hard valve seat 54 are of one-piece, unitary and homogenous construction. The valve body 42 preferably is made of bronze or brass. If desired, it can be made of steel, preferably a stainless steel. The valve body 42 preferably is cast and thereafter portions of it are machined including, for example, the integral hard valve seat 54, a portion of the valve assembly port 56, parts of the inlet 72 and outlet 74, and threaded sections of the port 56, inlet 72 and outlet 74. Such a valve body 42 is of economical construction and has an integral hard valve seat 54 that is durable and long lasting.

Where this type of valve body 42 is used, no conventional threaded cap, such as the conventional threaded cap 43 shown in FIG. 2, is needed or used. If present, the conventional threaded cap 43 is removed. If present, the horizontal swing check valve swing arm (not shown) and the disc (not shown) that is attached to the swing arm are also removed. As a result, the swing check valve swing arm recess 82 (FIG. 2) of the valve body 42 is unobstructed and free of the aforementioned swing arm check valve components.

If present and if desired, the hinge pin (not shown) can also be removed. If needed, a seal plug 80 (FIG. 1) is inserted into the hinge pin bore (not shown) in the valve body 42. The plug 80 can be of elastomeric construction, can be a threaded fastener, or some other sealing arrangement. If desired, a gasket (not shown) can be captured between an enlarged head 81 of the plug 80 and the valve body 42.

Before attaching a cap 44 constructed in accordance with the present invention to the valve body 42, the valve stem 50 is inserted into the valve stem guide 46 of the cap 44 forming a piston valve assembly 51 (FIG. 1) of the invention. The valve assembly 51 is then maneuvered so the valve disc 52 of the piston 48 is inserted into the valve assembly port 56 in the valve body 42 until the external threads 60 of the cap 44 engage with the internal threads 58 of the valve assembly port 56. The cap 44 is threaded into the port 56 until the generally planar bottom surface 68 of its outwardly extending cap flange 66 abuts against a complementary generally planar outer surface 70 that encircles the port 56. Preferably, no seal or gasket is required or used between the cap flange 66 and outer sealing surface 70 encircling the valve assembly port 56 of the valve body 42.

Where the valve assembly 51 is used in the retrofitting or conversion of a Y-pattern horizontal swing check valve into a Y-pattern piston check valve 40 of the invention, the conventional threaded cap 43 (FIG. 2) is removed along with the horizontal swing check valve swing arm (not shown) and disc (not shown) attached to the swing arm. Whether or not the swing arm hinge pin (not shown) is removed, a seal plug 80 preferably is inserted into the hinge pin bore (not shown) in the valve body 42. Thereafter, the valve assembly 51 is assembled to the valve body 42 in accordance with the aforementioned method steps.

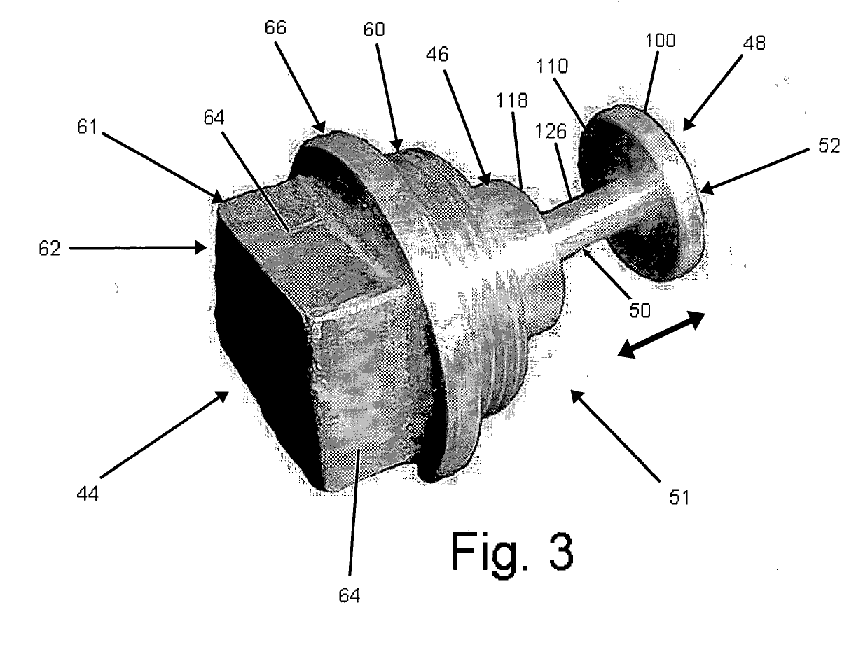

FIG. 3 shows the valve assembly 51. In the preferred embodiment shown in FIGS. 3-5, the cap 44 and valve stem guide 46 are of one-piece, unitary and homogenous construction. The cap 44 and valve stem guide 46 preferably are made of bronze or brass but can be made of steel, preferably stainless steel, where desired. Where of one-piece, unitary and homogenous construction, the cap 44 and valve stem guide 46 can be cast and machined, forged and machined to the extent machining is needed, or machined, such as by turning or the like.

If desired, the cap 44 and valve stem guide 46 can be thixotropically cast so as to be of one-piece, unitary and homogenous construction. Where thixotropically cast, the threads 60 of the cap 44 are also cast at the same time, reducing and preferably eliminating the amount of post-casting machining required. The guide 46 is advantageously thixotropically cast so as to produce the desired smooth surface finish along the surface that guides the stem 50 of the valve piston 48 such that no post-casting finishing, turning or other machining of the guide 46 is required nor performed.

Where thixotropically cast, the cap 44 and valve stem guide 46 preferably is of metallic construction that can include bronze and/or brass. Other metals and combinations of metals and/or metallic substances can also be used. The cap 44 and valve stem guide 46 can be thixotropically cast in accordance with one or more of the methods and apparatuses disclosed in one or more of U.S. Pat. Nos. 6,564,856; 6,427,755; 5,832,982; 5,630,466; 5,524,698; 5,355,933; 5,219,018; 4,964,455; and 4,510,987, the disclosure of each of which is expressly incorporated by reference herein.

The cap 44 can be constructed and arranged to facilitate engagement with a tool, such as a wrench, screwdriver, or the like. In the preferred embodiment shown in FIGS. 3-5, the outer end 62 of the cap 44 has a tool-engaging head 61 that includes a plurality of tool-engaging flats 64. The head 61 and tool engaging surfaces 64 preferably are formed at the same time the rest of the cap 44 is made including if thixotropically cast.

As is shown in FIG. 3, the valve piston 48 is reciprocably carried by the cap 44 such that the valve stem 50 of the piston 48 is reciprocably guided by the integral valve stem guide 46 of the cap 44. The outer surface 126 of the valve stem 50 preferably is substantially smooth to minimize frictional resistance between the stem 50 and valve stem guide 46 to enable the piston 48 to move between its closed position and an open position, and vice versa, as quickly and with as little resistance as possible.

The valve stem guide 46 extends outwardly from the cap 44 a sufficient length so as to retain enough of the valve stem 50 in the guide 46 such that the stem 50 never disengages from the guide 46 when the valve assembly 51 is assembled to the valve body 42. The guide 46 is generally cylindrical and has a stop surface 118 at its free end against which the valve disc 52 can abut when the piston 48 is disposed in a fully open position. The stop surface 118 has a shape complementary to the rear surface 110 of the disc 52 and has a surface area that is preferably at least 25 % of the surface area of the disc rear surface 110 so that the force of sudden impact against the guide 46 is more evenly spread out over the surface area of the stop surface 110 preventing damage to the disc 52 and the guide 46.

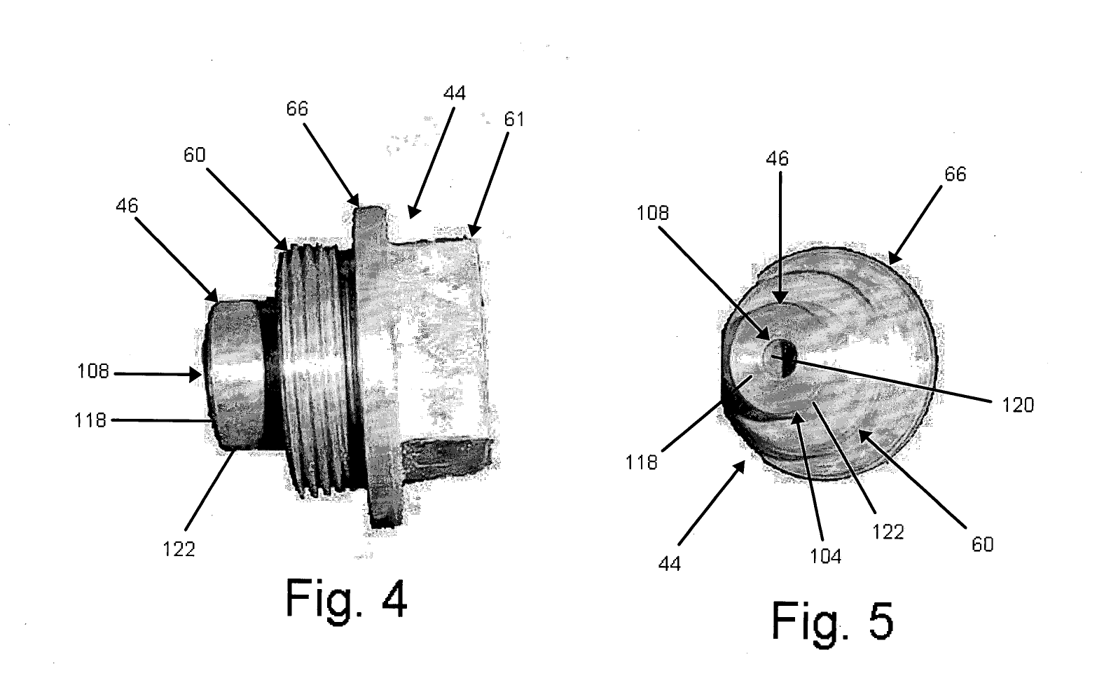

FIGS. 4 and 5 show the cap 44 and integral valve stem guide 46 with the valve piston 48 removed. The valve stem guide 46 preferably is elongate and generally cylindrical. It has an endless annular sidewall 104 with an inner surface 120 (FIG. 5) that defines an elongate valve stem guide bore 108 (FIG. 5) in which the valve stem 50 (FIG. 3) of the piston 48 is reciprocably received. The inner surface 120 preferably is substantially smooth to minimize frictional resistance between it and the valve stem 50 also to enable the piston 48 to move between its closed position and an open position, and vice versa, as quickly and with as little resistance as possible. The valve stem guide sidewall 104 has an outer surface 122 on the outside that extends an axial length to adjacent part of the cap 44 where the bottom edge of the innermost thread of the cap threads 60 begin.

The bore 108 preferably has a longitudinally extending center axis that substantially aligns with the center of the valve seat 54 when the cap 44 is assembled to the valve body 42. For example, the center axis of the bore 108 in the valve stem guide 46 of the cap 42 preferably is at least generally coincident with the centerline 128 shown in the valve body 42 depicted in FIG. 2 that extends through the center of the valve seat 54 and valve orifice 94 when cap 43 shown in FIG. 2 is removed and replaced with cap 42 (FIGS. 3-5).

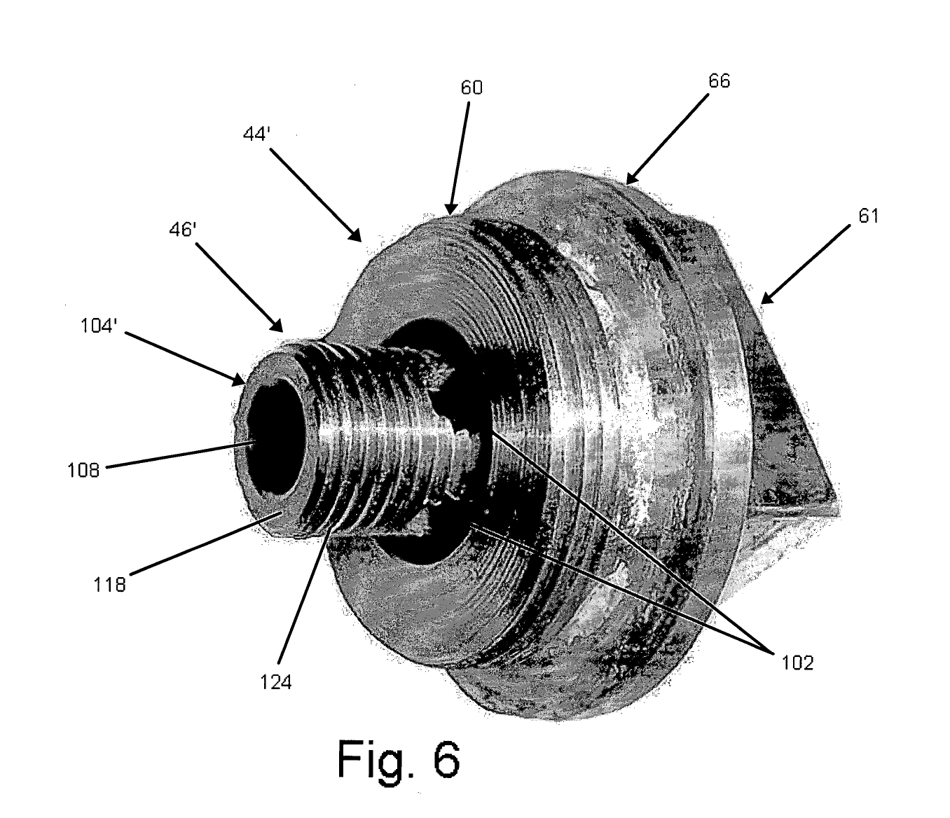

FIG. 6 illustrates another preferred embodiment of a cap 44′ that includes a valve stem guide 46′ that is formed of a separate component that is assembled to the cap 44′ to form a cap that functions like the cap 44 shown in FIGS. 3-5. The guide 46′ is elongate, generally cylindrical and can be tubular. The guide 46′ engages the cap 44′ adjacent one end in a manner that securely attaches it to the cap 44′.

In the preferred embodiment shown in FIG. 6, the guide 46′ has threads that engage complementary threads (not shown) of the cap 44′. In the preferred embodiment shown in FIG. 6, the guide 46′ has external threads 124 that engage internal threads (not shown) of a threaded bore (not shown) in the cap 44′ to positively attach the guide 46′ to the cap 44′. If desired, a thread locking compound or an adhesive can be used to prevent disengagement.

If desired, the guide 46′ can be bonded to the cap 44′ such as by welding or the like. Where the guide 46′ is welded to the cap 44′, inertia welding can be used. Where bonded in such a manner, the guide 46′ need not be threaded.

Where the valve stem guide 46′ is threaded, the free end of the guide 46′ can be constructed so as to facilitate engagement with a tool (not shown) used to assemble the guide 46′ to the cap 44′. For example, the guide 46′ can have one or more recesses, such as slots or the like, that receive part of a tool, such as a blade of a screwdriver or the like, that is used to assemble the guide 46′ to the cap 44′.

The valve stem guide 46′ also has one or more radially extending ports 102 that permit fluid within the valve 40 to communicate with the valve stem guide bore 108 to facilitate fluid pressure equalization of fluid within the bore 108. Each port 102 can be a drilled hole, such as depicted in FIG. 6, or can be formed in the sidewall 104′ of the guide 46′ using another forming process. Such fluid pressure equalization advantageously enables the piston 48 to more easily reciprocate during operation, particularly where a fluid having a viscosity greater than one, such as is the case for oil, is flowing through the valve 40.

The cap 44 depicted in FIGS. 3-5 can also be configured so its valve stem guide 46 has one or more such ports 102 (not shown in FIGS. 3-5). Where cast, one or more ports 102 preferably are cast-in-place, thereby eliminating any separate forming operation that would ordinarily be required. Where thixotropically cast, one or more ports 102 are cast-in-place eliminating any separate forming or machining that would ordinarily be required.

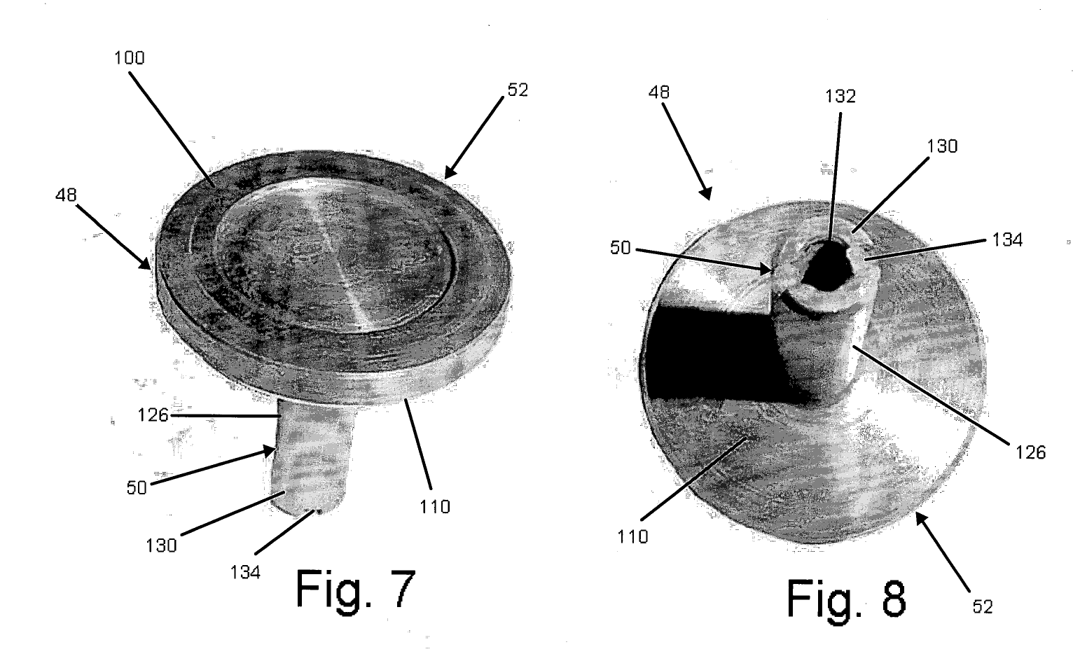

FIGS. 7 and 8 illustrate in more detail a preferred embodiment of a valve piston 48 constructed in accordance with the invention. The piston 48, including its stem 50 and disc 52, is of one-piece, unitary and homogenous construction. The piston 48 is preferably made of bronze or brass, but can be made of steel, such as stainless steel, if desired. The piston can be machined, such as out of bar stock or the like, and can be forged and machined, to the extent any post-forging machining is needed.

The disc 52 has a rear surface 110 that stops against a stop surface 118 at the free end of the valve stem guide 46 or 46′ when the piston 48 is located in an open position that preferably is a fully open position. Where the stop surface 118 has a larger surface area such as depicted by the guide 46 shown in FIGS. 3-5, the larger stop surface 118 preferably is substantially parallel to the rear surface 110 so as to more evenly spread the force of the disc 52 impacting against the guide 46 when the piston 48 is opening during operation. This advantageously minimizes and preferably prevents damage to the disc 52 as well as the guide 46, which extends valve life.

The disc 52 preferably has a circular shape with a diameter that is greater than the outer diameter of the valve seat 54. During valve closing, when the stem 50 laterally shifts or displaces within the guide 46 as needed to self-adjust for misalignment or mislocation between the valve body 42 and cap 44, the disc 52, in part because of its oversized construction, advantageously still enables its front sealing surface 100 to make proper sealing contact with the valve seat 54.

While the sealing surface 100 can be formed of the entire front surface of the disc 52 such that the entire front surface of the disc 52 is configured to complementarily mate with the seat 54, the sealing surface 100 preferably is an annular upraised portion of the front surface of the disc 52. The sealing surface 100 preferably is substantially flat and coplanar in order to make at least line contact with the sealing surface 98 of the seat 54 about the entire periphery of the seat 54, ensuring a good fluid-tight seal when closed.

The valve stem 50 preferably is of tubular construction such that it has an annular sidewall 130 that defines a cavity 132. The cavity 132 helps reduce the mass of the stem 50, which reduces the inertia of the piston 48 thereby enabling it to more quickly open and close. This advantageously increases response time and reduces the amount of fluid that can leak before the piston 48 fully closes. The cavity 132 preferably is elongate and of generally circular cross section. If desired, it can extend substantially the length of the stem 50.

The free end of the valve stem 50 can be constructed and arranged to engage a tool, such as where lapping of the sealing surface 100 of the disc 52 against the sealing surface 98 of the seat 54 is desired. In the preferred embodiment shown in FIGS. 7 and 8, the free end of the stem 50 has a recess 134 formed therein that is constructed and arranged to engage a tool that preferably is a screwdriver or the like. The recess 134 shown in FIGS. 7 and 8 is slot-shaped.

If desired, the piston 48 can be cast and machined to the extent needed after casting. For example, where the valve stem 50 is configured with a cavity 132, the cavity 132 can be drilled after casting. Where conventionally cast, the stem 50 and disc 52 preferably are precisely machined, particularly to impart the desired surface finish to the outer surface 126 of the stem 50, to ensure that the center of the disc 52 is substantially coincident with the longitudinally extending center axis of the stem 50, and to ensure that the sealing surface 100 of the disc 52 is substantially planar and generally perpendicular to the longitudinally extending center axis of the stem 50.

In one preferred embodiment, the piston 48 is thixotropically cast, such as in accordance with the thixotropic casting methods, materials and apparatuses discussed above, such that it preferably does not need any post-casting machining. Thixotropic casting of the piston 48 also advantageously imparts the outer surface 126 of the valve stem 50 with a desirably smooth as-cast surface finish that minimizes friction between the valve stem 50 and valve stem guide 46 during valve operation, forms the cavity 132 in the stem 50, and produces a sealing surface 100 of the disc 52 that is desirably planar and centered and perpendicular relative to the center axis of the stem 50. The tool engaging slot 134 can also be cast-in-place.

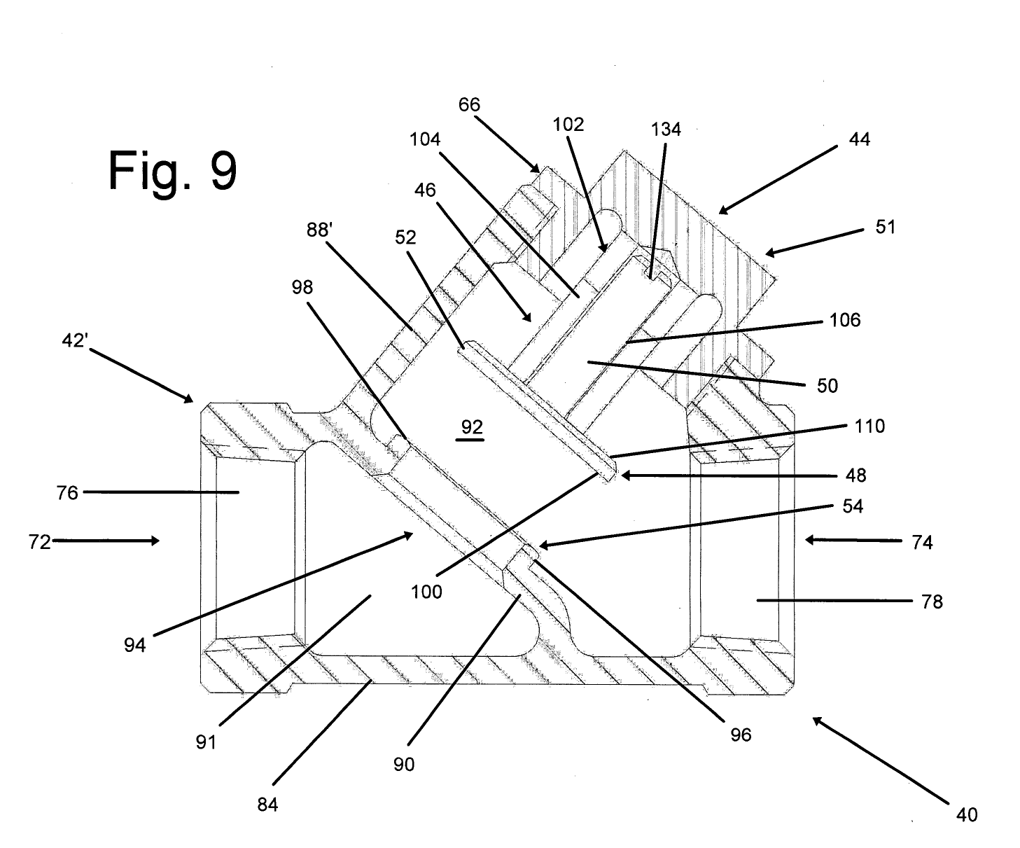

FIG. 9 illustrates a Y-pattern piston check valve body 42′ specifically constructed for use as the valve body for a Y-pattern piston check valve 40 of the invention as it lacks any swing arm recess 82 (FIG. 2) required in a Y-pattern horizontal swing check valve body. As a result, the assembly port sidewall 88′ of the valve body 42′ is uninterrupted and preferably is substantially straight along the region of the cross section shown in FIG. 9. Otherwise, the remainder of the Y-pattern piston check valve body 42′ has an external and internal configuration that is very similar to, if not virtually the same as, the Y-pattern horizontal swing check valve body 42 shown in FIGS. 1 and 2.

A Y-pattern piston check valve body 42′ made in accordance with the invention preferably is constructed so its dimensions A and B are within the appropriate range listed in Table 1 above for the corresponding valve size and intended valve class (e.g., class 125, class 150, class 200 or class 300) for which the valve 40 is intended. Valve body 42′ preferably is also constructed so as to produce a Y-pattern piston check valve 40 in accordance with the invention that complies with MSS Specification SP-80, preferably Type 3, even though it is not a horizontal swing check valve. As a result, a Y-pattern piston check valve 40 made in accordance with the invention using a Y-pattern valve body 42′ constructed in accordance with that depicted in FIG. 9 is particularly well suited for use in the same applications where a bronze Y-pattern horizontal swing check valve of MSS Specification SP-80, Type 3, construction is ordinarily used. This enables the Y-pattern piston check valve 40 of the invention to be used in new installations where a conventional bronze Y-pattern horizontal swing check valve would normally be used as well as to replace a conventional Y-pattern horizontal swing check valve that is already installed in the field.

A Y-pattern piston check valve body 42′ made in accordance with the invention can be cast and machined to form the integral hard valve seat 54, the threads 58 and outer sealing surface 70 of the valve assembly port 56, the threads 76 of the inlet 72, and the threads 78 of the outlet 74. No other machining is required. Its machining cost over a Y-pattern horizontal swing check valve body of the same size is reduced because no hinge bore is used in a Y-pattern piston check valve body 42′. In addition, since no swing check valve swing arm recess is needed, less material is used, reducing casting costs.

Where conventionally cast, the valve body 42′ preferably is cast of bronze and is of one-piece, unitary and homogenous construction. If desired, the valve body 42′ can be cast of brass. In another preferred embodiment, the valve body 42′ is cast of stainless steel.

In one preferred embodiment, the Y-pattern piston check valve body 42′ is thixotropically cast of a suitable thixotropic casting material that can include bronze, brass, another metal, or a combination thereof. Where thixotropically cast, the valve body 42′ preferably requires little to no machining as the integral hard valve seat 54, the threads 58 and outer sealing surface 70 of the valve assembly port 56, the threads 76 of the inlet 72, and the threads 78 of the outlet 74, are all preferably cast-in-place.

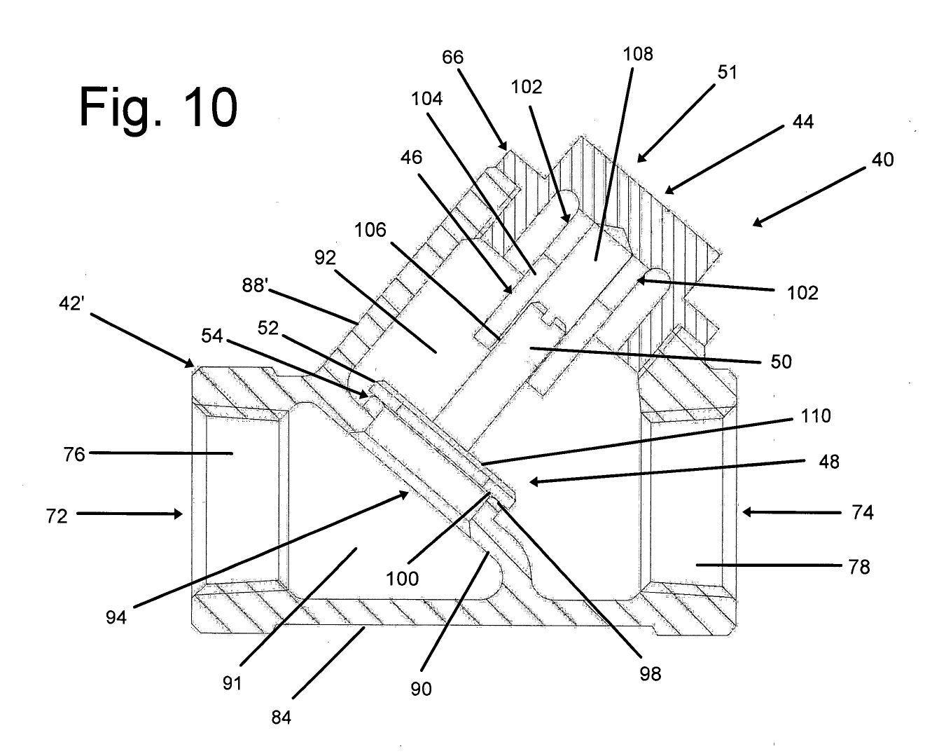

The Y-pattern piston check valve 40 depicted in FIG. 9 shows the valve piston 48 in a fully open position with the rear surface 110 of the disc 52 bearing against the free end of the valve stem guide 46. The valve 40 depicted in FIG. 10 shows the valve piston 48 in a fully closed position with the front sealing surface 100 of its disc 52 in contact with the outer sealing surface 98 of the valve seat 54. The valve 40 is generally horizontally oriented such that closing of the valve piston 48 is gravity assisted.

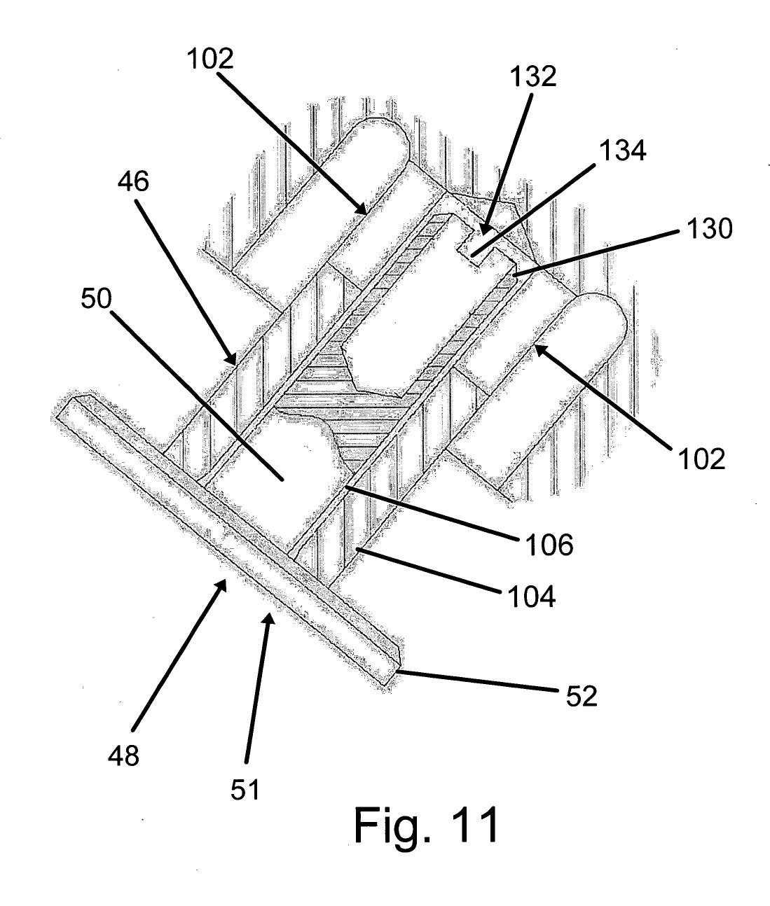

Referring additionally to FIG. 11, the space intentionally provided between the valve stem 50 and the valve stem guide 46 is identified by reference numeral 106. FIG. 11 depicts the valve stem 50 centered within the bore 108 in the valve stem guide 46 such that this tolerance or gap 106 between the stem 50 and guide 46 is elongate, annular in cross section, and cylindrical in shape. In a preferred embodiment, the size of this tolerance or gap 106 in a radial direction, when the central longitudinal axis of the stem 50 is substantially coincident with the central longitudinal axis of the bore 108 in the guide 46, is at least eight thousandths of an inch and preferably at least about fifteen thousandths of an inch.

The tolerance or gap 106 is selected so as to provide a fit between the valve stem 50 and valve stem guide 46 that is looser than a standard sliding fit. For example, in one preferred embodiment, the tolerance or gap 106 is selected to provide a fit between the stem 50 and guide 46 that is RC5 or looser (e.g., RC6, RC7, RC8 or RC9). In another preferred embodiment, the tolerance or gap 106 is selected to provide a fit between the stem 50 and guide 46 that is a close running fit (e.g., ISO H8/f7), a free running fit (e.g., ISO H9/d9), or a loose running fit (e.g., ISO H11/c11).

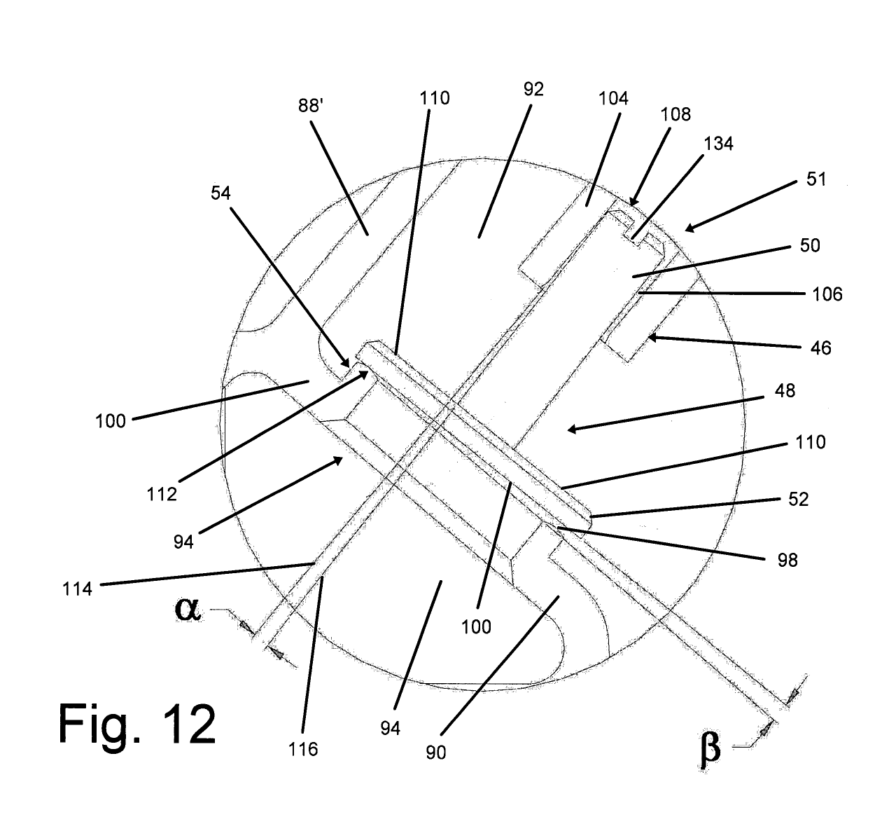

Referring additionally to FIG. 12, the tolerance or gap 106 is selected to enable the angle of the valve stem 50 to angularly deviate relative to the valve stem guide 46 by as much as 3.5°. For example, such a tolerance or gap 106 permits the center longitudinal axis of the valve stem 50 to angularly deviate from being coincident with the center longitudinal axis of the bore 108 in the valve stem guide 46 as much as 3.5°. In one preferred embodiment, the tolerance or gap 106 is selected to provide the stem 50 with the ability to angularly deviate relative to the guide 46 as much as at least 1.5° and no greater than 3.5°. In one preferred embodiment, the tolerance or gap 106 is selected to provide the stem 50 with the ability to angularly deviate relative to the guide 46 a maximum of between about 2° and about 2.5°.

A piston-type valve 40 made in accordance with the invention is configured with such a tolerance 106 that provides such a critical angular tolerance to enable the valve disc 52 with enough self-adjustability when closing that it is advantageously able to compensate for mislocation and/or misalignment between the valve cap 44 and the valve body 42 or 42′, such as is typically caused by unpredictable and relatively large variations in tolerances between them, to fluid tightly seal against the valve seat 54. This advantageously enables a threaded cap 44 equipped with an integral valve stem guide 46 constructed in accordance with the invention to be threaded into a threaded valve assembly port 56 opening in a Y-pattern valve body 42 or 42′, including a Y-pattern swing check valve body 42, in spite of the rather large tolerances and tolerance variations normally found in these components.

For example, such a cap 44, equipped with external NPT threads, can be successfully used with a Y-pattern valve body 42 or 42′, equipped with internal NPT threads, despite the fact that the typical tolerance variations permitted for such an arrangement typically result in some sort of mislocation or misalignment between the valve cap 44 and the valve body 44. Such mislocation or misalignment causes the center longitudinal axis of the bore 108 in the valve stem guide 46 to be angularly and/or laterally offset from the centerline of the valve body 42 or 42′ that extends through the valve seat 54. As a result, the center longitudinal axis of the bore 108 in the valve stem guide 46 is not coincident with the centerline of the valve seat 54 of the valve body 42 or 42′. Providing such a tolerance 106 between the valve stem 50 and valve guide 46 enables the valve piston 48 to adjust when closing to compensate for any lateral or angular deviation of the bore center axis from being coincident with the valve seat centerline.

As is shown in FIG. 12, mislocation and/or misalignment between the cap 44 and the valve body 42 has resulted in the valve stem 50 being angularly offset, due to the tolerance or gap 106 provided between the valve stem 50 and valve stem guide 46, at an angle, α, that preferably is no greater than about 3.5°. For example, angle, α, is defined in FIG. 12 as the angle between a first line 114 that is substantially parallel to the central longitudinal axis of the valve guide bore 108 and a second line 116 that is substantially parallel to the central longitudinal axis of the valve stem 50. Line 114 is coincident or substantially parallel with a longitudinally extending portion of the inner surface the valve stem guide sidewall 104. Line 116 is coincident or substantially parallel with a longitudinally extending portion of the outer surface the valve stem 50. In another preferred embodiment, the tolerance or gap 106 is selected to provide a maximum angular tolerance of about 2° and no more than 2.5° enabling the valve disc 52 to correspondingly adjust relative to the valve seat 54 when the piston-type valve sealing element is closing.

When initial contact is made between the valve disc 52 and the valve seat 54, such as when the valve piston 48 is closing, the outer sealing surface 100 of the disc 52 is disposed at an angle, β, relative to the contact region of the outer surface 98 of the seat 54 that is substantially the same as angle, α. Due to the gap or tolerance 106 between the exterior of the valve stem 50 and the interior of the valve stem guide 46, part of the valve stem 50 can laterally displace within the valve guide bore 108 to permit the valve disc 52 to laterally displace relative to the valve seat 54 as well as permit the valve disc 52 to pivot about its initial point of contact, such as contact point 112 shown in FIG. 12, so as to enable its outer sealing surface 100 to make sealing contact with the valve seat 54 about its entire periphery (e.g., such that line contact occurs between the disc 52 and seat 54).

During operation, with fluid flowing from the inlet 72 through the valve 40 out the outlet 74, the valve piston 48 is urged toward an open position until it reaches the fully open position shown in FIG. 9 such that the rear surface 110 of its valve disc 52 abuts against the end of the valve stem guide 46. Should the direction of fluid flow through the valve 40 reverse, the pressure of the fluid flowing in an opposite direction acts against the rear surface 110 of the disc 52, pulling the disc 52 toward the seat 54 until it reaches a closed position, like that shown in FIG. 10, and fluid-tightly seats against the seat 54.

If the disc 52 is angularly misaligned relative to the seat 54, such as if the valve stem guide 46 is angularly misaligned relative to the seat 54, the tolerance or gap 106 between the valve stem 50 and valve stem guide 46 permits the disc 52 to pivot about its initial point of contact 112 with the seat 54, such as is depicted in FIG. 12, because the stem 50 can laterally displace and/or angularly pivot within and relative to the valve stem guide bore 108. The fluid pressure due to reversed fluid flow causes the disc 52 to further pivot about the contact point 112 such that the part of its outer sealing surface 100 not in contact with the seat 54 continues to move toward the seat 54 until all of the sealing surface 100 of disc 52 bears against the seat 54, such as in the manner depicted in FIG. 10. As a result of this advantageous construction, positive fluid tight sealing takes place despite the presence of misalignment and/or mislocation between the valve cap 44 and valve body 42 or 42′.

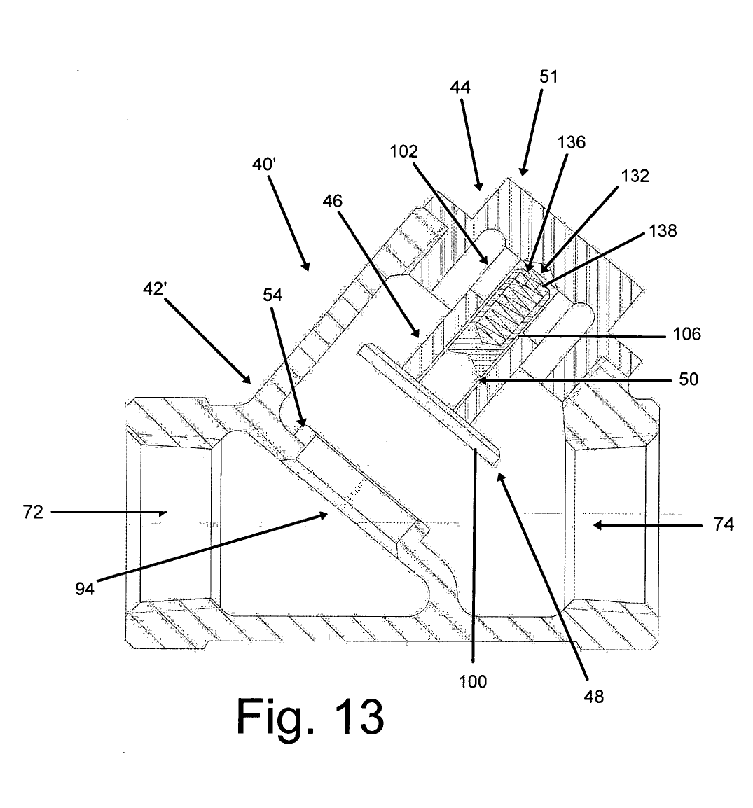

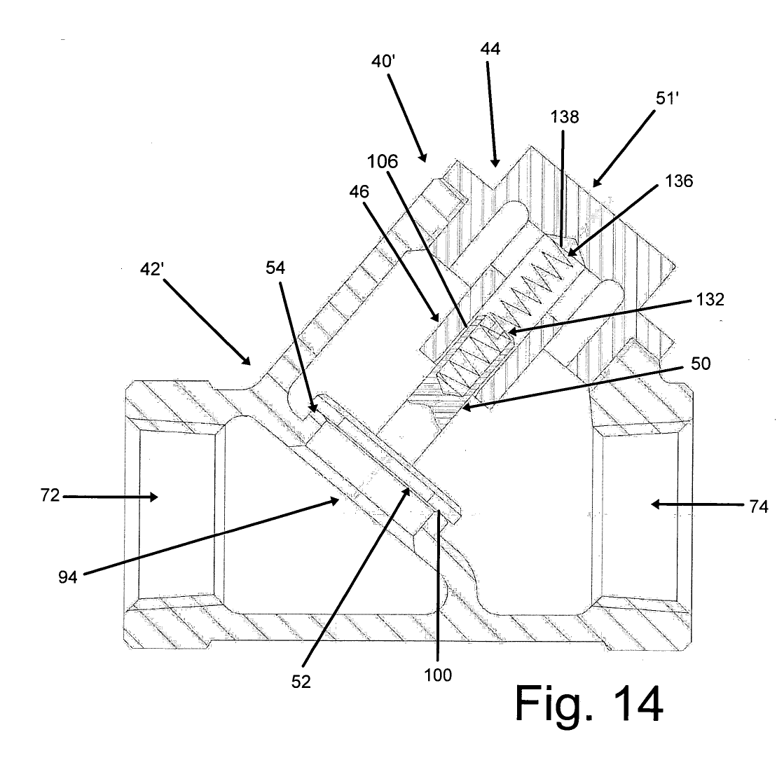

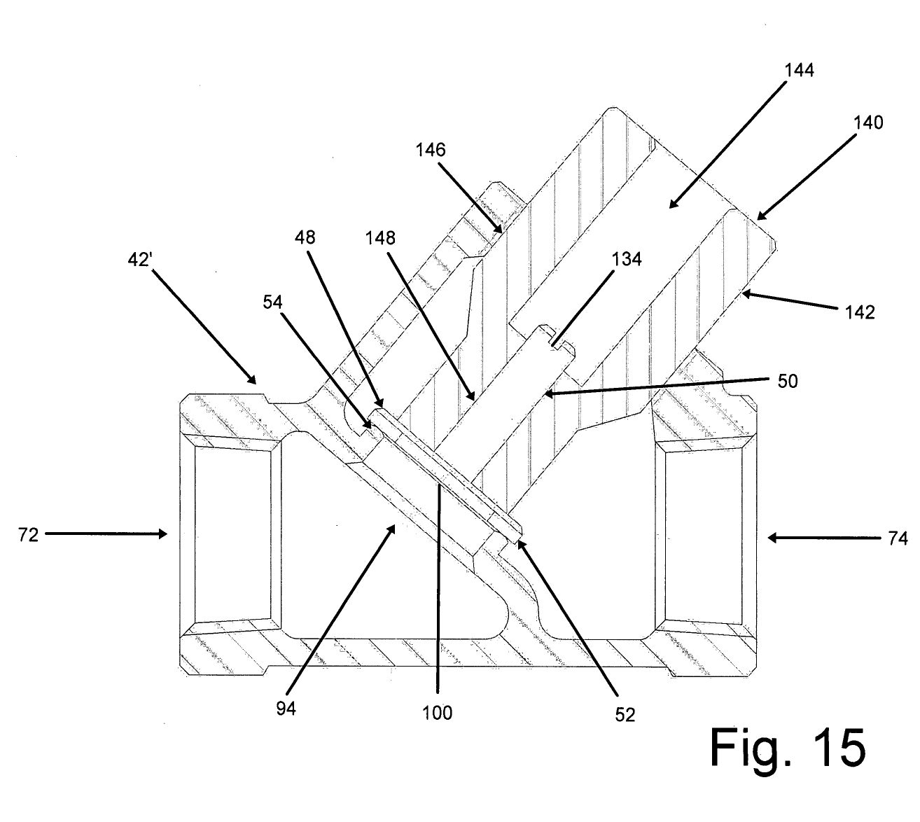

FIGS. 13 and 14 illustrate another preferred embodiment of a Y-pattern piston valve 40′ constructed in accordance with the invention that has a biasing element 136 that urges the valve piston 48 toward the closed position depicted in FIG. 14. The biasing element 136 preferably is a compression spring 138, such as a coil spring. In one preferred embodiment, the coil spring 138 is made of a stainless steel, Inconel, or the like. The spring 138 is seated in the cavity 132 in the valve stem 50 between the valve stem 50 and the end wall of the valve stem guide 46.

The valve assembly 51 of valve 40′ is constructed in accordance with the valve assembly 51 shown in the valve 40 depicted in FIGS. 9-12. By being configured with a spring 138 in the manner depicted in FIGS. 13 and 14, valve 40′ advantageously can be used in positions that deviate from horizontal because the valve 40′ does not need to rely on gravity in any way whatsoever to facilitate valve closing.

FIG. 16 illustrates a lapping fixture 140 that can be used to rotate the sealing surface 100 of the valve disc 52 against the valve seat 54 in a lapping operation where lapping is desired or needed. The lapping fixture 140 has a sidewall 142 that defines a tool access port 144 in which a tool (not shown) is inserted to engage the end of the valve stem 50. The outer surface of the sidewall 142 has a threaded portion 146 that threadably engages the threads 58 of the valve assembly port 56 in the valve body 42′. The lapping fixture 140 has a necked down bore 148 that receives and generally centers the valve stem 50 relative to the valve seat 54 such that the disc 52 overlies the seat 54. Preferably, a blade of a screw driver (not shown) is inserted through the tool access port 144 and into the slot 134 in the end of the valve stem 50 and the screw driver is rotated to lap the sealing surface 100 of the disc 52 against the valve seat 54 by rotating the disc 52 relative to the seat 54. Improved sealing can result from lapping.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

1. A Y-pattern piston check valve comprising:
a metal Y-pattern valve body of one-piece unitary and homogenous construction having a hard valve seat therein;
a metal valve sealing element of one-piece unitary and homogeneous construction having a cylindrical stem and round valve head at one end of the stem that has a generally planar hard valve seat sealing surface; and
a valve guide that slidably reciprocably receives and guides the elongate stem of the valve sealing element between a closed position where the hard valve seat sealing surface of the valve head bears against the hard valve seat of the Y-pattern valve body and an open position where the hard valve seat sealing surface of the valve head is spaced from the hard valve seat of the Y-pattern valve body.

2. The valve assembly of claim 1 wherein one of the valve sealing element and the valve guide are of tubular construction and the other one of the valve sealing element and the valve guide is slidably reciprocably received in the one of the valve sealing element and the valve guide with a loose sliding fit provided therebetween.

3. The valve assembly of claim 1 wherein the elongate stem of the valve sealing element comprises an elongate post of circular cross section that is longer than it is wide.

4. The valve assembly of claim 1 wherein there is a loose sliding fit between the stem of the valve sealing element and the valve guide.

5. The valve assembly of claim 1 wherein the valve guide further comprises an end cap that is threadably received by the Y-pattern valve body with the valve guide being integral with the end cap.

6. The valve assembly of claim 1 further comprising a biasing element that is disposed inside one of the valve stem and the valve guide which urges the head of the valve sealing element toward a closed position.

7. The valve assembly of claim 6 wherein the biasing element comprises a coil spring that is captured in compression.

8. The valve assembly of claim 1 wherein the valve stem has a first diameter, the valve guide has a second diameter, the valve head has a third diameter, and the valve head diameter has a diameter greater than the valve stem diameter and the valve guide diameter that provides an overhang of at least about one-eighth of an inch.

9. The valve assembly of claim 1 wherein the valve stem has a first diameter, the valve guide has a second diameter, the valve head has a third diameter, and the valve guide diameter is no greater than one-third the valve head diameter.

10. The valve assembly of claim 9 wherein the valve guide diameter is about one-fourth the valve head diameter.

11. The valve assembly of claim 10 wherein the valve guide diameter is about one-fourth the valve head diameter.

12. The valve assembly of claim 1 wherein the valve guide has a diameter and the valve head has a thickness that is about one-half the diameter of the valve guide.

13. The valve assembly of claim 1 wherein there is an angular tolerance between the valve stem and the valve guide between one degree and three and one-half degrees when disposed in a closed position.

14. The valve assembly of claim 13 wherein there is an angular tolerance between the valve stem and the valve guide of about two degrees.

15. A Y-pattern piston check valve comprising:
a metal valve body that has an interiorly disposed metal valve seat with an orifice therethrough, an inlet, an outlet, and a valve assembly port;
a metal end cap that threads into the valve assembly port and which carries a tubular metal valve guide;
a metal valve sealing element that has a circular disk head and a stem extending therefrom that is slidably reciprocably received by the metal valve guide such that it can slidably reciprocate between a closed position where the circular disk head bears against the metal valve seat and an open position disposed from the closed position where the circular disk head is not in contact with the metal valve seat; and
wherein there is a tolerance between the stem and valve guide that provides a loose sliding fit therebetween that permits angular and lateral self-adjustment of the valve sealing element as it moves toward its closed position to fluid-tightly seal against the valve seat.

16. The valve according to claim 15 further comprising a biasing element that is disposed inside one of the valve stem and the valve guide which urges the head of the valve sealing toward a closed position.

17. The valve according to claim 15 wherein the valve guide is disposed in line with the valve sealing element stem.

18. The valve according to claim 15 wherein the circular disk head is of one piece and unitary construction and which has an outer face that is a sealing surface that directly contacts the valve seat when the valve sealing element is disposed in the closed position.

19. The valve according to claim 15 wherein the valve guide and end cap are of one-piece and unitary construction.

20. The valve according to claim 15 wherein the valve body and valve seat are of one-piece and unitary construction.

21. The valve according to claim 15 wherein the valve sealing element is of one-piece and unitary construction.

22. The valve assembly of claim 15 wherein the end cap comprises a thixotropically cast end cap.

23. The valve assembly of claim 22 wherein end cap and valve sealing element do not require any post-casting machining.

24. A valve comprising:
a metal valve body of one-piece and unitary construction that has an interiorly disposed metal valve seat with an orifice therethrough and a threaded valve assembly port;
a metal end cap of one-piece and unitary construction that threads into the threaded valve assembly port and which carries a tubular metal valve guide;
a metal valve sealing element of one-piece and unitary construction that has a circular disk head and a stem extending therefrom that is slidably reciprocably received by the metal valve guide such that it can slidably reciprocate between a closed position where the circular disk head bears against the metal valve seat and an open position disposed from the closed position where the circular disk head is not in contact with the metal valve seat;
wherein there is a tolerance between the stem and valve guide that provides that permits the valve sealing element to angularly adjust by as much as 3.5° relative to a central longitudinal axis of the valve guide enabling self-adjustment of the valve sealing element as it moves toward its closed position to fluid-tightly seal against the valve seat.
